(19) United States
(12) Patent Application Publication
(10) Pub. No.: US 2026/0339105 A1
(43) Pub. Date: Oct. 29, 2026

(54) OPTICAL ARRANGEMENT HAVING AN OPTICAL WAVEGUIDE FOR RADIATING-IN VIRTUAL IMAGES, AND HEAD-MOUNTED DISPLAY

(71) Applicant: tooz technologies GmbH, Aalen (DE)

(72) Inventor: Jan Mathis Kaster, Heubach (DE)

(73) Assignee: tooz technologies GmbH, Aalen (DE)

(21) Appl. No.: 19/700,765

(22) Filed: Jun. 8, 2026

Related U.S. Application Data
(63) Continuation of application No. PCT/EP2024/082021, filed on Nov. 12, 2024.

(30) Foreign Application Priority Data
Dec. 12, 2023 (DE) 102023134822.1

(51) Int. Cl. G02B 27/01

(52) U.S. Cl. CPC G02B 27/0172

(57) ABSTRACT

An optical arrangement includes a lightguide for radiating in images that are perceptible as virtual images and a fastening device for fastening the optical arrangement to a person’s head. The fastening device includes an output coupling region for arrangement of a projector and the lightguide has an input coupling region. The optical arrangement includes a further lightguide with an input coupling device and an output coupling device. The further lightguide is arranged in the beam path between the output coupling region of the fastening device and the input coupling region of the lightguide.

### CROSS REFERENCE TO RELATED PATENT APPLICATIONS

This application is a continuation application of international patent application PCT/EP2024/082021, filed on Nov. 12, 2024, and designating the U.S., which claims priority to German patent application DE 102023134822.1, filed on Dec. 12, 2023, both of which are hereby incorporated by reference in their entireties

### FIELD OF DISCLOSURE

The present disclosure relates to an optical arrangement, which is wearable in front of the eyes, and to a head-mounted display.

### BACKGROUND

Head-mounted displays (HMD), for example in the form of smartglasses or AR (augmented reality) headsets or VR (virtual reality) headsets or MR (mixed reality) headsets or AR or VR or MR glasses or VR or MR helmets, are used in numerous contexts. In this context, after light waves for generating a virtual image have been input coupled into a lightguide, they are usually guided by means of total-internal reflection until they are output coupled. When a user looks through a head-mounted display, e.g., “augmented reality glasses,” or “AR glasses” for short, they see an input coupled or superimposed “virtual image” overlaid on their image of the physical world (“real image”). This overlay is achieved by way of the lightguide which is also referred to as a beam combiner and which, on the one hand, is transparent to ambient light but, on the other hand, also steers a beam generated by an external picture generator into an eye box, in which the eye of a user may be situated. The eye perceives this beam as a virtual image. A respective imaging path can be defined for the purpose of describing the beam path for the image of the physical surroundings and the beam path for the input coupled virtual image. In this case, an imaging path is understood to mean the path of light from the object, e.g., an object in the physical surroundings, or from a picture generator/projector, which emits the virtual image to be input coupled, to the location of image creation or perception of the image representation, e.g., the eye of a user or the eye box. Within the scope of augmented reality (AR), the surroundings visible to a user are augmented by virtue of digital elements being added to a live view of the surroundings, i.e., an imaging path of the physical surroundings. Within the scope of virtual reality (VR), a user can perceive only virtual image representations. Thus, the imaging path of physical surroundings is replaced by an imaging path of virtual surroundings (simulated surroundings).

In the case of a head-mounted display, e.g., in the case of AR headsets, the image generated by a picture-generating unit or a display is input coupled into the lightguide, reflected one or more times within the lightguide by means of total-internal reflection and finally output coupled such that a user of the head-mounted display can see a virtual image. The region in space from where the virtual image is visually perceivable by a user is also referred to as an eye box. The two outer faces of the lightguide are frequently embodied as parallel plane faces so that neither optical refractive power nor aberrations, which impair the image quality, are generated within the lightguide. Moreover, head-mounted displays, e.g., AR headsets, may comprise a lightguide and one or more additional lenses (push-pull lens principle) per eye. This one lens or these multiple additional lenses serve to correct the ametropia (refractive error) or presbyopia of the eye (pull lens) and/or to let the virtual image appear in focus at a desired distance (pull lens) without impairing the image of the physical surroundings (push lens).

Related art relating to near-eye displays and head-mounted displays is described for example in documents CN 1 14 415 228 A and CN 1 15 702 313 A.

Standard solutions for glasses that allow the superimposition or radiating-in of virtual content, e.g., images, are currently commercially available. A single standard glasses size is thus offered (one size fits all/most). This relates for example to AR (augmented reality) glasses but also to VR (virtual reality) glasses and MR (mixed reality) glasses. The input coupling position of the picture-generating light is predefined accordingly and a spectacle frame is developed to match. In the case of reflective input coupling elements, the pupil size, which is to say the projector exit pupil, which usually corresponds to the pupil of the eye, and the coupling angle and thus the size of the light cone to be input coupled specify the thickness of the lightguide used for the input coupling, when the pupil lies on the input coupling element, for example the input coupling mirror.

Standard solutions for AR glasses are currently commercially available (one size fits all/most). This limits the choice of spectacle frames, or spectacle frames are developed for specific waveguides. The spectacle frames and waveguides are larger and heavier than necessary for an individual user or specific groups of users (excluding the group of most/all users). In the production of corresponding glasses and the design development thereof, it is therefore sought to minimize the size of the lightguide and to customize the contour of the lightguide, or make the contour compatible with as many spectacle frames in a conventional size as possible. In extreme cases of waveguide size minimization, the position of the pupil input coupling into the lightguide, e.g., the AR waveguide, is predefined by the size adjustment and is no longer coincident with the frame-related projector input coupling position. Although the size of the lightguide fits most frames, the light might no longer be able to be coupled into the lightguide for individual frames.

Usually, a plane waveguide for e.g., AR systems is designed such that the pupil input coupling lies in the region of a spectacle temple, the nosepiece or along the outer contour. A fully minimized AR lightguide, however, generally has a contour for which the position of the pupil input coupling does not lie in the region of the desired input coupling, e.g., in the region of a spectacle temple, the nosepiece or along the outer contour.

### SUMMARY

Against this background, an object of the present disclosure is to provide an advantageous optical arrangement and a head-mounted display which reduce the above-described disadvantages of the above-described solutions. These objects are achieved by an optical arrangement including a lightguide for radiating in images that are perceptible as virtual images and a fastening device for fastening the optical arrangement to a person’s head and by a head-mounted display having such an optical arrangement. Further advantageous configurations of the disclosure are discussed below.

The optical arrangement according to the disclosure, which typically is wearable in front of the eyes or generally configured as a head-mounted display, comprises a lightguide for radiating in or superimposing images that are perceptible as virtual images (virtual content). The optical arrangement further comprises a fastening device for fastening the optical arrangement to a person’s head. The fastening device can be configured for example as a temple, in particular a nosepiece or earpiece. The fastening device, for example the temple, comprises an output coupling region for arrangement of a projector. The output coupling region can be formed by a fastening-device region in which light output coupling by a projector is provided, which is to say an output coupling region of a projector can be arranged, or in other words a region where the light beam containing the image leaves the projector. Optionally, the optical arrangement can have a projector with an output coupling region, wherein the output coupling region is arranged in the region of or on the fastening device. The lightguide has an input coupling region, in particular a pupil input coupling region. The input coupling region can have an input coupling optical unit.

The optical arrangement additionally comprises a further lightguide with an input coupling device and an output coupling device, wherein the further lightguide, in particular for the purpose of transferring the pupil input coupling, is arranged in the beam path between the output coupling region of the fastening device and the input coupling region of the lightguide, which is to say the first-mentioned lightguide is arranged to radiate in the virtual images in the direction of the eye.

In an advantageous variant, the lightguide, which is to say in other words the first lightguide, is embodied as a size-minimized lightguide and the further lightguide, which is to say in other words the second lightguide, is embodied as a length-corrected and/or rotational-angle-corrected further lightguide. The length-corrected and/or rotational-angle-corrected further lightguide can be arranged for displacement inside a frame contour of the fastening device, in particular inside a spectacle lens frame contour, and thus allow individual adaptation. The individual configuration both of the size-minimized lightguide and of the length-corrected and/or rotational-angle-corrected further lightguide can be based on a simulation and/or optimization of the respective lightguide design. In this context, one or more customization parameters can be used.

The present disclosure has the advantage that it offers a highly customizable optical arrangement, e.g., in the form of an HMD. The further lightguide, which forms an intermediate link between the projector and the lightguide for radiating in light waves in the direction of the eye, makes it possible to combine both a customized and size-minimized lightguide and an individual frame which has for example an individual contour. This affords additional degrees of freedom in the design and technical configuration of corresponding glasses, for example AR glasses. Overall, this considerably improves the acceptance and comfort for a user in comparison with solutions known to date.

It is possible, for example, for the above-described further lightguide to be geometrically and functionally configured such that it can be adapted to the bridging distances and bridging angles to be expected. It is, however, also possible to provide a set of further lightguides, the individual lightguides each being configured for certain bridging distances and bridging angles. The aforementioned variants make it possible to adapt a customized lightguide for glasses to a customized spectacle frame easily and cost-effectively in manufacturing terms.

In an advantageous configuration variant, the output coupling region of the fastening device is connected or connectable, e.g., directly connected or connectable, to the input coupling device of the further lightguide (hereinafter also referred to as bridging lightguide). The output coupling device of the further lightguide can be connected or connectable, e.g., directly connected or connectable, to the input coupling region of the lightguide, which is to say the lightguide for radiating in light waves in the direction of the eye (hereinafter also referred to as AR lightguide).

The further lightguide is typically configured as a periscope lightguide. In connection with the present disclosure, a periscope lightguide is understood to mean a lightguide that brings about a graduated beam offset between the input coupled light and the output coupled light. The input coupled light beams and the output coupled light beams can for example run parallel to one another, in particular in terms of the respective chief rays. As an alternative, the input coupled light beams and the output coupled light beams can form an angle which is smaller than 90°, typically smaller than 45°.

The input coupling device and/or the output coupling device of the further lightguide can be refractive and/or diffractive and/or reflective and/or transmissive and/or comprise at least one holographic optical arrangement.

The lightguide (AR lightguide) and/or the further lightguide (bridging lightguide) can be configured in accordance with at least one fixed customization parameter, which is to say be adapted for a specific person. The at least one customization parameter can be an intraocular distance, which is to say the intraocular distance of a person, and/or a head width, which is to say the head width of a person, and/or at least one geometric parameter of a spectacle frame and/or a position of the input coupling region of the lightguide and/or a position of the output coupling region, e.g., of the temple and/or of the projector. The at least one customization parameter can also be the length of the further lightguide, e.g., in a sagittal direction, or another geometric parameter and/or the position of the further lightguide relative to the lightguide (AR lightguide) and/or a rotational angle, e.g., an azimuthal rotational angle, of the further lightguide (bridging lightguide) relative to the lightguide (AR lightguide).

The lightguide (AR lightguide) and/or the further lightguide (bridging lightguide) can be formed from segments, which is to say have a segmented configuration. The individual segments are arranged adjoining one another or next to one another or directly adjacent to one another in a plane perpendicular to a viewing direction of a user through a spectacle lens comprising the lightguide or in a plane spanned by the extent of the lightguide. A segmented configuration is advantageous for easy and cost-effective manufacture. Joints between the individual segments are joined, e.g., by adhesive bonding, in index-matched fashion.

In a further variant, the optical arrangement comprises a spectacle frame with a frame contour and the further lightguide is arranged for displacement inside the frame contour. This makes it possible to flexibly adapt a customized lightguide (AR lightguide) to a specified frame contour of the spectacle frame.

The further lightguide can be configured as a plane lightguide. The further lightguide is typically designed to conduct light waves in a sagittal direction, which is to say along a longitudinal axis.

Advantageously, a rotational angle of a longitudinal axis of the further lightguide, e.g., the azimuthal rotational angle, in relation to a fixed input coupling point into the lightguide and a rotational angle, e.g., the azimuthal rotational angle, of an image to be input coupled in relation to a fixed input coupling point into the further lightguide have the same absolute value and the same direction. For example, an optical device which brings about a complete image inversion without a beam offset can be arranged in the beam path between a projector and the input coupling device of the further lightguide. This can be realized for example by means of an azimuthally rotatable Schmidt-Pechan prism or by means of at least two mirrors. The aforementioned variants ensure correct transmission of the image in spite of the adjustment of the beam path by means of the further lightguide.

In an advantageous variant, the optical arrangement comprises a projector, which is arranged and/or set such that the exit pupil of the projector lies on the input coupling region, e.g., of a corresponding input coupling optical unit, of the lightguide (AR lightguide), which is to say is coincident with the lightguide entrance pupil. This ensures correct input coupling into the lightguide. As an alternative, the exit pupil of the projector can also lie in the further lightguide. This makes it possible to significantly reduce the thickness and weight of the lightguide. In addition, the pupil position is accessible independently of a mirror, for example for scattered light optimizations (cf. Lyot stop).

The optical arrangement can further comprise a projector which is arranged for axial displacement along the fastening device, e.g., along a spectacle temple. The displaceability allows individual adaptation of the exit pupil position of the projector and thus correct adaptation thereof to the lightguide entrance pupil.

In a further variant, the optical arrangement comprises an optical device, which is arranged in the beam path between the projector and the further lightguide and is designed for adaptation, in particular individual adaptation for a specific person, of the exit pupil position of the projector. The optical device can be e.g., a zoom optical unit or an optical relay system.

The optical arrangement can comprise an optical device for correcting an angle of the fastening device, e.g., of a temple, in relation to the input coupling device of the further lightguide, wherein the optical device is arranged between the output coupling region of the projector and the input coupling device of the further lightguide. The optical device can comprise a compensation wedge, in particular in the form of a prism, and/or at least two reflective optical elements, e.g., mirrors. The optical device allows customized correction of individually different angles between the spectacle frame and the spectacle temples, which is to say individual adaptation to the anatomy of the respective person.

In an advantageous variant, the optical arrangement comprises at least one lens, e.g., a push and/or pull lens. The at least one lens advantageously comprises a cutout or recess adapted to the geometry of the further lightguide. In addition or alternatively, the refractive index and/or the refractive index dispersion of the further lightguide can be adapted to the refractive index and/or the refractive index dispersion of the at least one lens and/or to an interface, e.g., air and/or adhesive, arranged between the further lightguide and the lens.

The head-mounted display according to the disclosure comprises an above-described optical arrangement according to the disclosure. It has the same features and advantages as the optical arrangement according to the disclosure.

In principle, the optical arrangement according to the disclosure and/or the head-mounted display according to the disclosure can be configured as AR glasses or MR glasses or VR glasses or a corresponding helmet.

There follows a description of how a customized and/or size-minimized lightguide can be produced. A corresponding lightguide, in particular a customized and/or size-minimized lightguide produced as described below and in the context of the exemplary embodiments, can be a constituent part of the optical arrangement according to the disclosure. The term “customized lightguide” is understood as meaning a lightguide which is adapted to a group of persons or users defined by at least one fixed parameter or parameter range or to a specific person in terms of at least one degree of design freedom. The degree of design freedom can be e.g., the geometric configuration of the lightguide and/or the position and/or the size of an output coupling region, etc. The term “size-minimized lightguide” is understood in the present case as meaning a lightguide which is adapted to a group of persons or users defined by at least one fixed parameter or parameter range or to a specific person in terms of the dimensions of the lightguide, in such a way that at least one, typically more, sizes that determine the dimension of the lightguide are minimized. For example, it is possible to minimize the length and/or the width of the lightguide with respect to a fixed coordinate system, or else the overall volume and thus the weight of the lightguide. In particular, the input coupling region and/or the pupil replication region and/or the output coupling region of the lightguide can be minimized.

To produce a customized and/or size-minimized lightguide, a lightguide including the input and output coupling device and two-dimensional pupil replication for an individual or a group of individuals is designed as small as possible and supplemented by a sufficiently large wafer region, which is to say e.g., by a substrate in the form of a disk. From this wafer, which is to say a semifinished product comprising the lightguide, a cutout can be made for any desired spectacle frame and/or any desired eye position. With an individual cutout, input and output coupling regions and the pupil replication region can be designed as small as possible, as described below.

Besides the specific customization for a user or a frame model, input and output coupling and pupil replication regions can be extended moderately for specific groups of users, for example for groups of users with intraocular distances of 49 to 58 mm, 58 mm to 67 mm, 67 mm to 76 mm. Other ranges are of course possible. In that case, multiple semifinished product variants (wafers with lightguide regions) are defined, for example three variants, which are selected according to respective user requirements and cut out individually for the frame and/or user.

The lightguide with input and output coupling and pupil replication elements, for example with partially transmissive mirrors, is size-minimized on the basis of a desired field of view of a virtual image and positional tolerances of the optical system with respect to the user. Parameters for establishing individual groups of users or for customization for a person can be in particular the meridional intraocular distance range and/or the distance range from the waveguide to the eye along the line of sight to the center of the virtual image and/or the angular orientation of the waveguide in relation to lines of sight of the image contents (for example the line of sight to the image center) and/or the size of the eye pupils and/or the viewing direction field and the respective fields of view for the virtual image and the transmission and/or the distance from the eye pupil to the focal plane of the virtual image and/or the waveguide material and/or the position of the input coupling of the image information of an image collimator.

To deduce the positional tolerances of a spectacle frame, it is possible to simulate slipping on a representative nasal bridge. The underlying spectacle frame can be a commercially available model from an optician. Lenses, referred to as push and pull lenses, can be or can have been mounted on the front and rear of the lightguide. These lenses establish the focal plane for the virtual image (e.g., 1 m) and are used to correct possible visual defects. For the viewing angle region of the eye by rotation of the eyeball, a region of ±17.5° about a viewing direction can be assumed, it being possible for the viewing direction to be oriented by -2.5° downward in relation to the meridional plane. In addition, an axially symmetrical field of view of ±30° can be assumed, which is to say a region in which symbols are usually still perceived in the peripheral field of view.

Within the viewing direction cone, the eye is oriented e.g., such that the line of sight to the center of a virtual image one meter away along the line of sight is directed away from the center of the pupil, tilted by -10° about the meridional plane. About this line of sight to the image center, it is possible to construct a field of view with e.g., ±17.7°, of which the interface with the lightguide rear side, what is referred to as the “output footprint,” can be used to identify the region from which light is output coupled in the direction of the eye. In this respect, the specification can be a square virtual image with image corners at ±25° field of view from the line of sight to the image center.

On this basis, it is possible to span a volume which contains all the viewing directions for a filled eye pupil and indicates the range of movement of the eye pupil. For this purpose, an optimization can be used to set two orthogonal elevation angles of an eye model used, such that the eye model looks into the corners of the image.

The area spanned by the movement of the pupil centers is spherical in the ideal case and inter alia depends on the distance between the eye and the lightguide. Generated together with this variation in distance along the line of sight is what is referred to as the “eye box,” which is to say a spatial region in which the eye pupil is located for all relevant variations, in particular with a variable angular orientation in accordance with the rotation of the eye. In addition to this variation, there are positional tolerances for the described optical system relative to the eye pupil or the eye box. These tolerances are for example a possible slipping of the glasses on the nasal bridge downward, e.g., 4 mm downward, or upward, e.g., 1 mm upward, a lateral tolerance of the fastening of the optical system inside the spectacle frame, e.g., ± 1 mm, and measurement tolerances for the intraocular distance, e.g., ± 1 mm.

For the variations described, a partly automated or automated analysis process can be used to record footprints and generate an integrated quadrilateral footprint therefrom. The footprint is generally no longer exactly square. The same applies to the eye box. The footprint integrated across all relevant variants predefines the necessary minimum area for output coupling, this being independent of the selected lightguide technology, for example independent of the configuration as diffractive or reflective couplers and pupil replicators.

The integrated footprint can be taken as a basis to define a reference geometry consisting of reference coordinate systems, planes, axes and points, and reference curves. With the reference geometry, for the use case of reflective pupil replication, and input and output coupling, it is possible to automatically ascertain, in an optimization, the parameters for as small as possible a lightguide which output couples the input coupled light with a uniform radiation intensity (unit [W/sr]) in the direction of the eye, by predefining the lightguide material (e.g., the glass N-LASF46B by Schott), the eye pupil size to be filled (e.g., 1.5 mm diameter), the desired angular distribution of the pupil replication (e.g., 1°), the lateral minimum extent of the angular distribution (e.g., 1 mm to 1.5 mm) and the desired input coupling position of the image information, e.g., close to the spectacle temple. The described reference geometry is necessary for a uniform distribution and output coupling of the light, as a result of which the virtual image looks the same in terms of color and brightness for visual perception even with the variances described.

The optical design can be sufficiently defined by specifically designed partially transmissive mirrors. The geometric parameters, which can be automatically optimized, are the propagation volume of the light inside the lightguide, the number and position of the partially transmissive mirrors, the thickness of the lightguide, and the geometry of the blanks from which the semifinished product in wafer form is formed. The elevation angles of the input and output coupling devices are designed on the basis of the line of sight to the image center and the pantoscopic angle and the wrap angle (tilt angle of the spectacle lens in relation to the sagittal plane). This can be effected directly inside the geometry model or by means of a coupled optical simulation.

Depending on the azimuthal position of the reference geometry, for example depending on the footprint width and/or the input coupling position of the image collimator, the lightguide volume can be limited to the footprint dimensions in automated fashion by condition-controlled cuts. This avoids superfluous lightguide regions that are unfavorable in terms of the volume and in terms of optical properties, for example scattered light. The necessary reflectances and transmittances of the partially transmissive mirrors can also be ascertained in automated fashion. They depend inter alia on the number of mirrors, which can be varied in automated fashion in the geometry optimization. The aforementioned basic radiometric properties of the respective mirrors are important for a coupled non-sequential optical simulation, which makes it possible to finely optimize all of the above-described parameters. In particular, this relates to a multi-target optimization in terms of volume minimization and optical performance, for example a geometry adaptation that reduces sensitivity to tolerances and scattered light, but can also include coupling to structural-mechanical simulations, for example in order to reduce the sensitivity of the optical system in terms of temperature variations and other mechanical loading. The partially transmissive mirrors can be implemented for example by dielectric multilayer coatings or holographic optical elements (HOEs).

To fasten the image collimator to the lightguide and align it along a temple of a spectacle frame, it is possible to provide a corresponding optical group which itself can be designed in the form of a lightguide. By way of a suitable optical design, the optical group can decouple the alignment of the image collimator along the spectacle temple and the required direction of arrival of the chief ray of the image center from one another. This optical group can be important as a boundary condition for system optimizations.

The segments from which the above-described semifinished product in wafer form is formed can be interconnected by conventional methods, for example by adhesive bonding or anodic bonding. The contour can be cut to size individually by conventional separating methods, for example by cutting or dividing by means of ultrashort pulse lasers.

The optical design process described produces an extent-minimized lightguide that can be integrated in a semifinished product in wafer form. This semifinished product can be cut out individually for a corresponding frame shape and/or the corresponding group of users. The optical design can be carried out e.g., in Creo Parametric. Parametrically coupled optical simulations and fine optimizations can be carried out for example with Zemax.

The cutting out of the lightguide that provides the virtual image for the AR optical system can be adapted individually, e.g., for different frames and/or user characteristics, such as head width and intraocular distance, although the underlying lightguide for the virtual image with input and output coupling and the pupil replication regions geometrically remains the same or must be present only in a few variants. For example, it is possible to provide variants for three intraocular distance ranges and optionally further variants for ranges of pantoscopic angles and wrap angles, which is to say a total of for example twelve variants. This is particularly advantageous for customization of the optical system in the field of mass production.

By virtue of the method described, a size-minimized lightguide, including input coupling and output coupling regions, which can be inserted into a sufficiently large wafer and cut out therefrom individually is enabled. The lightguide input coupling regions and/or the lightguide output coupling regions and/or the pupil replicators can be diffractive or reflective. The lightguide material can consist of glass or plastic. The outer contour of the semifinished product in wafer form is ideally selected such that, during the cutting out, as little scrap as possible is created, in particular in order to reduce costs and waste, for example with a polygonal base area (e.g., equilateral hexagon).

The described size minimization of the lightguide, in particular of the input coupling region, the pupil replication region and the output coupling region, makes it possible to reduce the size of the glasses to the required dimension and does not need to fit everyone - it is made to fit. This makes the optical system more lightweight, this being a core requirement for AR/VR/MR systems. The individual cutting out can make it possible to use one lightguide design, or a few lightguide design variants, for a lot of different frames and users. This makes it possible to save costs and contributes to making mass production suitable.

The disclosure is explained in detail below on the basis of exemplary embodiments with reference to the accompanying figures. Although the disclosure is more specifically illustrated and described in detail by means of the exemplary embodiments, the disclosure is not restricted by the examples disclosed and other variations can be derived therefrom by a person skilled in the art, without departing from the scope of protection of the disclosure.

The drawings are not necessarily accurate in every detail and to scale and can be presented in enlarged or reduced form to provide better clarity. For this reason, functional details disclosed here should not be understood as restrictive, but merely to be an illustrative basis that gives guidance to a person skilled in this technical field for using the present disclosure in various ways.

The expression “and/or” used here, when it is used in a series of two or more elements, means that any of the elements listed can be used alone, or any combination of two or more of the elements listed can be used. If for example a composition containing the components A, B and/or C is described, the composition may contain A alone; B alone; C alone; A and B in combination; A and C in combination; B and C in combination; or A, B, and C in combination.

### BRIEF DESCRIPTION OF THE DRAWINGS

The disclosure will now be described with reference to the drawings wherein:

FIG. 1 schematically shows three variants of an optical arrangement according to the disclosure;

FIG. 2 schematically shows a spectacle lens for AR glasses with a conventional pupil input coupling position of the lightguide;

FIG. 3 schematically shows a spectacle lens for AR glasses with a fully minimized lightguide;

FIG. 4 schematically shows an optical arrangement according to the disclosure comprising the spectacle lens shown in FIG. 3;

FIG. 5 schematically shows a perspective view of a further lightguide;

FIG. 6 schematically shows a rotation of the further lightguide in relation to the input coupling region of the lightguide and the associated rotation of the projector image;

FIG. 7 schematically shows the setting of the pupil position as a function of the length of the further lightguide;

FIG. 8 schematically shows a Schmidt-Pechan prism and the use thereof for compensating for an image rotation;

FIG. 9 schematically shows further examples for correcting an oblique input coupling angle;

FIG. 10 schematically shows a temple angle correction by means of mirrors;

FIG. 11 schematically shows a further lightguide with a central pupil position;

FIG. 12 schematically shows a perspective view of a beam path through an optical arrangement according to the disclosure at an azimuthal rotational angle of the further lightguide of 145 degrees;

FIG. 13 schematically shows a perspective view of a beam path through an optical arrangement according to the disclosure at an azimuthal rotational angle of the further lightguide of 130 degrees;

FIG. 14 schematically shows a perspective view of a beam path through an optical arrangement according to the disclosure at an azimuthal rotational angle of the further lightguide of 115 degrees;

FIG. 15 schematically shows a view of the beam path shown in FIG. 14 through an optical arrangement according to the disclosure in a y-z-plane;

FIG. 16 schematically shows a view of the beam path shown in FIG. 14 through an optical arrangement according to the disclosure in an x-y-plane;

FIG. 17 schematically shows a view of the beam path shown in FIG. 14 through an optical arrangement according to the disclosure in an x-z-plane;

FIG. 18 schematically shows a semifinished product in the form of a wafer with a size-minimized lightguide;

FIG. 19 schematically shows a wafer formed from segments;

FIG. 20 schematically shows a detail of the wafer shown in FIG. 19;

FIG. 21 schematically shows a semifinished product in the form of a wafer with a non-customized lightguide;

FIG. 22 schematically shows a semifinished product in the form of a wafer with a size-minimized lightguide;

FIG. 23 schematically shows a semifinished product in the form of a wafer with three variants of size-minimized lightguide; and

FIGS. 24-29 schematically show a spectacle lens with a lightguide and the geometric parameters used in the course of a simulation for minimizing the size of the lightguide.

### DETAILED DESCRIPTION OF EXEMPLARY EMBODIMENTS

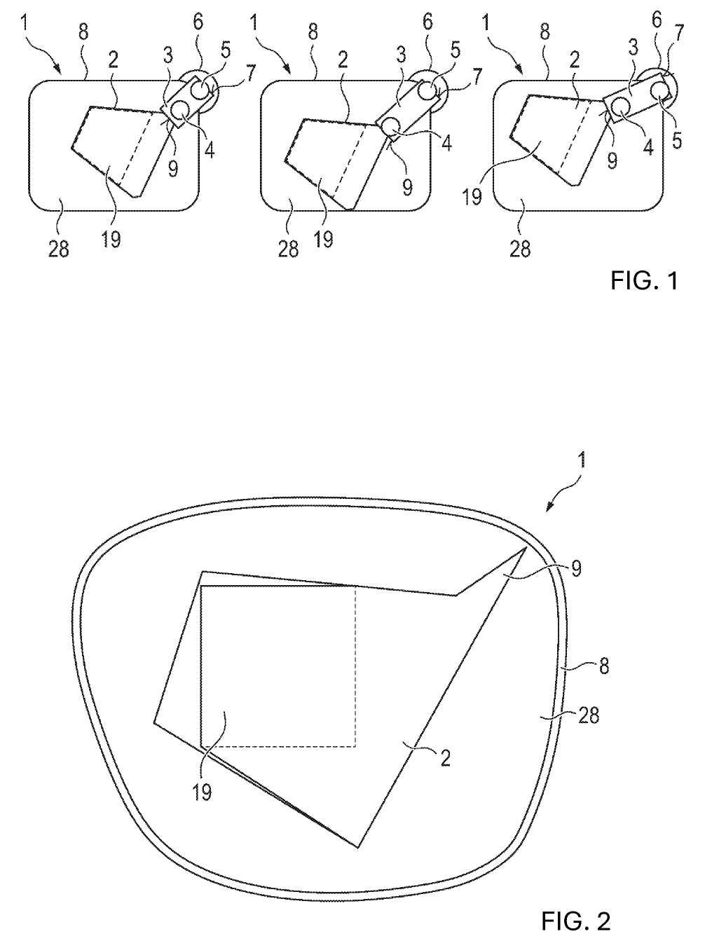

FIG. 1 schematically shows three variants of an optical arrangement 1 according to the disclosure using the example of an AR spectacle lens. The spectacle lens 28 shown is arranged in a frame 8 with a fastening device 6, e.g., a spectacle temple, and comprises a lightguide 2 with an input coupling region or input coupling device 9 for input coupling light beams from a projector (not shown) into the lightguide 2 and an output coupling region 19 for output coupling light beams from the lightguide 2 in the direction of an eye box or an eye of a person. In the three variants shown, the lightguide 2 is in each case adapted in terms of its position, which is to say the position of the output coupling device 19 and thus also the position of the input coupling region 9, on or in the spectacle lens 28 to a specific person. An output coupling region 7 for arrangement of the projector is arranged in the region of the fastening device 6.

For the purpose of bridging the respective distance between the output coupling region 7 and the input coupling region 9, the optical arrangement 1 has a further lightguide 3 with an input coupling device 5, which is arranged on the output coupling region 7, and an output coupling device 4, which is arranged on the input coupling region 9. The further lightguide 3 is thus arranged in the beam path in each case between the output coupling region 7 of the fastening device 6 and the input coupling region 9 of the lightguide 2. In the variants shown, the further lightguide 3 in each case has an adapted length and an adapted rotational angle with respect to the input coupling region 9 of the lightguide 2. The optical arrangement according to the disclosure thus makes it possible to integrate a customized, in particular size-minimized lightguide in any desired spectacle lens frame.

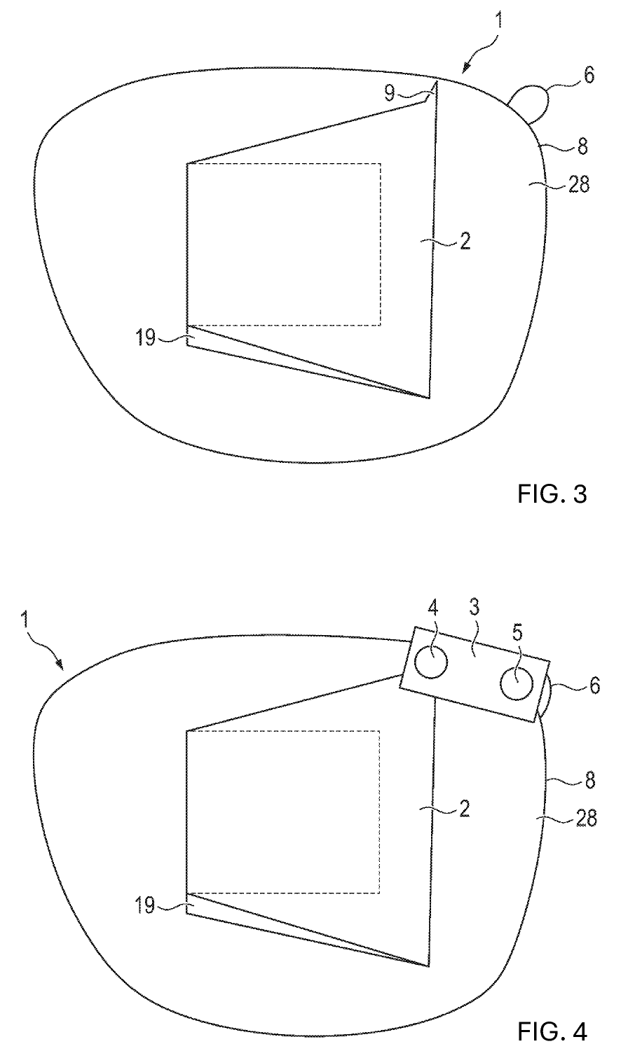

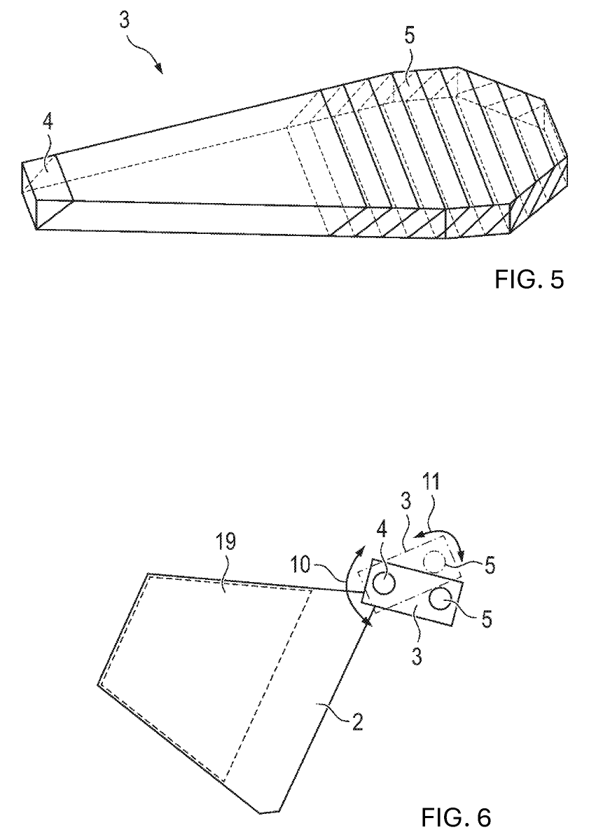

FIG. 2 schematically shows a spectacle lens 28 for AR glasses, which is to say e.g., a wafer comprising the lightguide and having at least one push and/or pull lens adhesively bonded thereto, with a conventional pupil input coupling position 9, which is to say a conventional position of the input coupling region 9, of the lightguide 2 at the position of a customary output coupling region 7 of the projector. Usually, a plane lightguide 2 for AR systems is designed such that the pupil input coupling 9 lies in the region of a spectacle temple 6, the nosepiece, or along the outer contour 8 of the wafer for a frame. A fully minimized AR lightguide 2, however, rather has the exemplary contour illustrated in FIG. 3. This lightguide contour is offset inside the frame contour in accordance with the customization parameters, for example the intraocular distance, specific spectacle frame and head width, etc. and the virtual image is transported to the input coupling position 9 of the AR lightguide 2 via a further lightguide 3, which is individually adapted for example and can be configured as a periscope lightguide. This is shown in FIG. 4. FIG. 4 thus shows an optical arrangement according to the disclosure in the form of an AR spectacle lens as part of a head-mounted display according to the disclosure in the form of AR glasses. In other words, the resulting distance between the output coupling region of the projector (not shown) of the AR glasses in the region of the fastening device 6 in the context of an optical arrangement 1 according to the disclosure is bridged by means of the further optical lightguide 3.

FIG. 5 schematically shows a perspective view of a further lightguide 3. The further lightguide 3 shown comprises an input coupling device 5 and an output coupling device 4, wherein, in the variant shown, the input coupling device 5 has an input coupling area larger than the output coupling area of the output coupling device 4. The further lightguide 3 shown is configured as a periscope lightguide. It can be a plane lightguide, which is to say designed to guide light waves in a sagittal direction.

FIG. 6 schematically shows a rotation 10 of the further lightguide 3 with respect to the input coupling region 9 of the lightguide 2 and the associated rotation 11 of the projector image. Since the further lightguide 3 is customized for the specific position of the projector input coupling and AR lightguide input coupling, in particular in terms of its length and an azimuthal rotational angle 10 relative to the AR lightguide 2, for a constant orientation of the virtual image it is necessary for the projector or the image to be rotated by the same angle, which is to say in terms of absolute value and direction by the same angle, azimuthally about the projector input coupling point or an input coupling point of the input coupling device 5. To rotate the image, use can be made of a customary optical unit, for example an azimuthally rotatable Schmidt-Pechan prism.

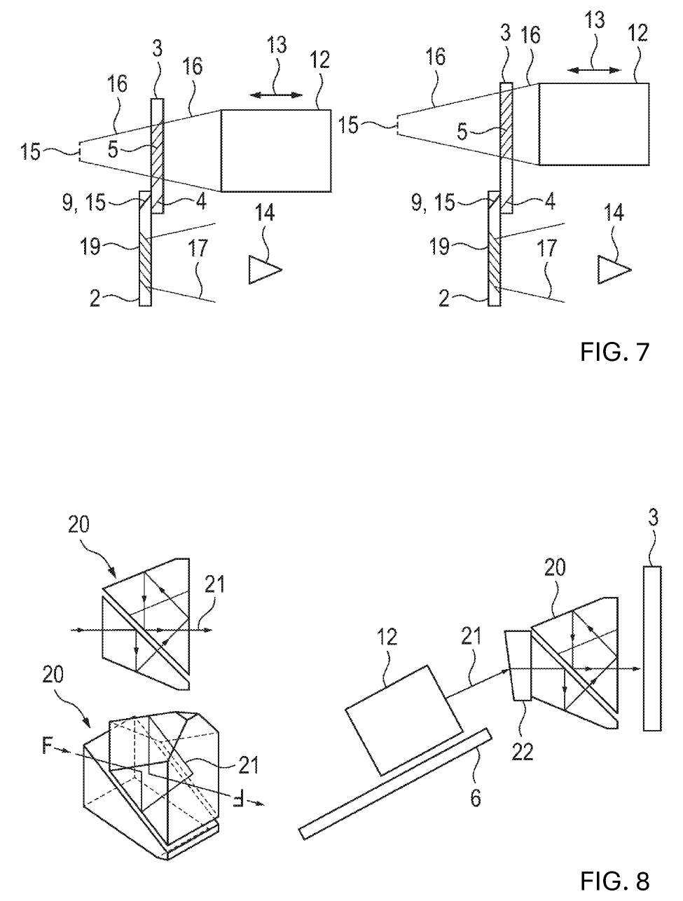

FIG. 7 schematically shows the setting of the pupil position 15 as a function of the length of the further lightguide 3 in the sagittal direction. The beam path from the projector 12 in the direction of the further lightguide is denoted by reference sign 16. The beam path from the output coupling device 19 in the direction of an eye 14 or an eye box is denoted by reference sign 17. The exit pupil position 15 of the projector 12 lies in the input coupling region 9, in particular on the input coupling optical unit, of the AR lightguide 2 and thus is coincident with the AR lightguide entrance pupil. The further lightguide 3 rotates about this point of rotation (see arrow 10 in FIG. 6). In order to decouple the requirement for the exit pupil position 15 from the length of the further lightguide 3, the projector 12 must be designed accordingly and for example axially displaced in its position (see arrow 13).

Instead of axially displacing 13 the projector 12, it is also possible to provide a corresponding zoom optical unit or an optical relay system. The Schmidt-Pechan prism 20 used for this in the example in FIG. 8 can, as a result of a modification, also at the same time be used, or supplemented by an optical unit 22, e.g., a compensation wedge or a prism, in order to decouple the angle of incidence of the chief ray of the image center from the axial orientation of the projector 12 along a spectacle frame 6. In FIG. 8, the left-hand side schematically shows the beam path 21 through a Schmidt-Pechan prism 20 for rotation of the image, and the right-hand side schematically shows the use thereof for compensating for a temple angle.

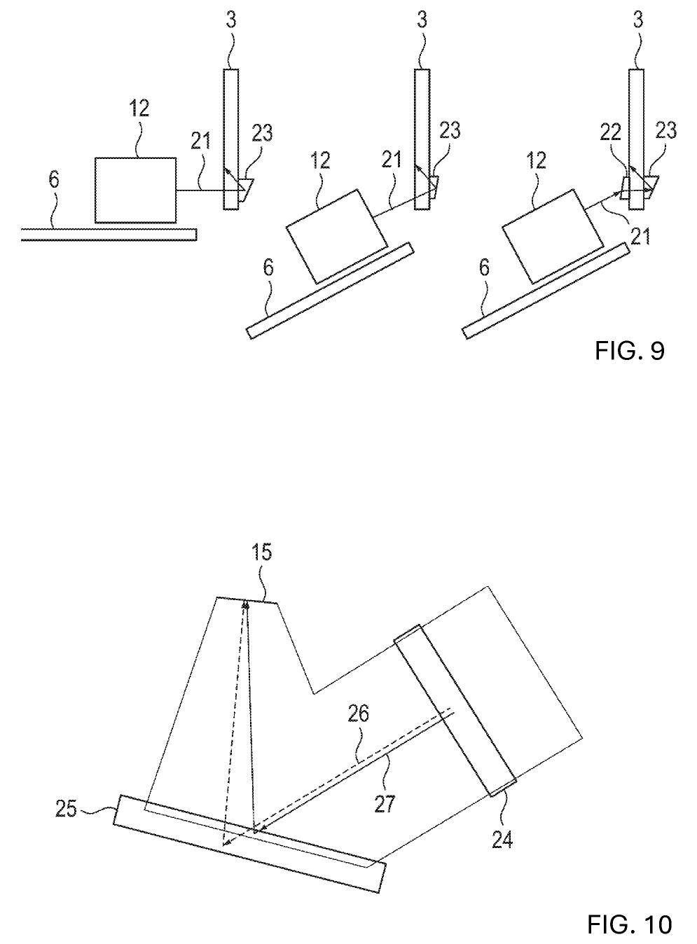

FIG. 9 schematically shows further examples for correcting an oblique input coupling angle by means of suitable optical units 22 and 23. FIG. 10 schematically shows a temple angle correction by means of two correspondingly aligned mirrors 24 and 25 as a further option. Beams characterizing two different points of an image are denoted by reference signs 26 and 27. Instead of an image aligning prism 20 or an azimuthal rotation of the projector 12, the azimuthal rotation can also be realized by one or more additional mirrors in the further lightguide 3, or upstream or downstream thereof in the beam path.

The input coupling and output coupling elements 4 and 5 for the further lightguide 3 can be refractive (e.g., in the form of prisms), reflective (e.g., one or more mirrors in each case) or diffractive (e.g., via one or more diffraction gratings). They can both be optimized, especially in terms of coupling efficiency, chromatic aberrations and scattered light. Depending on the coupling efficiency and beam propagation in the further lightguide 3, individual surfaces of the further lightguide 3 can be provided with absorber elements (e.g., apertures, coatings, etc.).

In the further lightguide 3, the elevation angle of the chief ray can be set via the coupling elements so that the action of the further lightguide 3 occurs as if coupling into the AR lightguide 2 takes place without any further lightguides 3.

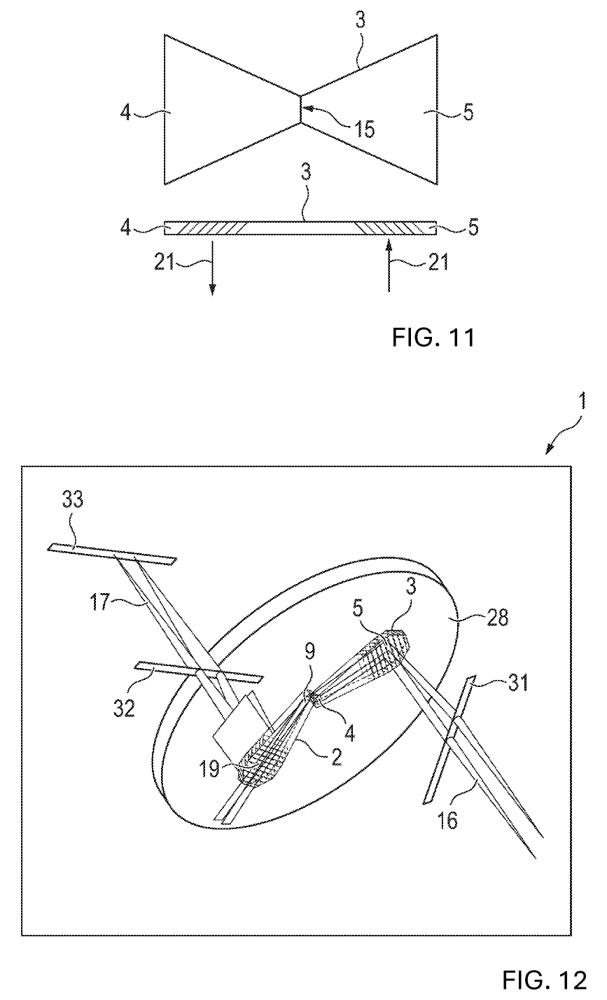

The further lightguide 3 can be configured as a dedicated component, or functionally integrated in the lenses, e.g., push and/or pull lenses, in combination with an adhesive with a high refractive index. In the coupling region close to the pupil position 15, the further lightguide 3 can also comprise multiple mirrors, whereby the further lightguide 3 can be made thinner. The input coupling optical unit for the AR lightguide 2 is generally coincident with the pupil position 15. In the case of a mirror, it can be formed in one piece. This limits the thickness of the respective waveguide as a function of the pupil diameter and the mirror orientation. As an alternative, the pupil position 15 can also be located in the further lightguide 3. For this purpose, the latter can have the form of a bow tie, as shown in FIG. 11. FIG. 11 schematically shows a further lightguide 3 with a central pupil position 15, in a plan view at the top and in a side view at the bottom. The beam path is identified by arrows with the reference sign 21. A corresponding configuration makes it possible to significantly reduce the thickness and weight of the lightguide. In addition, the pupil position 15 is accessible independently of a mirror, for example for scattered light optimizations (cf. Lyot stop). The AR lightguide 2 can generally also have two or more layers, it being possible for the layers to be rotated and displaced with respect to one another before they are secured in their relative position in relation to one another, for example by adhesive.

The exemplary embodiments according to the following drawings show a non-sequential optical simulation. The arbitrarily selected input and output coupling elements for the lightguide were in some cases partially transmissive mirrors. The AR lightguide 2 selected was a copy of the further lightguide 3, for the sake of simplicity. The pupil replication is therefore one-dimensional, and accordingly only a one-dimensional field was selected. The design can, however, also be used for a two-dimensional pupil replication, irrespective of the coupling principle (refractive, reflective or diffractive). The lightguides 2 and 3 are configured as plane lightguides by way of example.

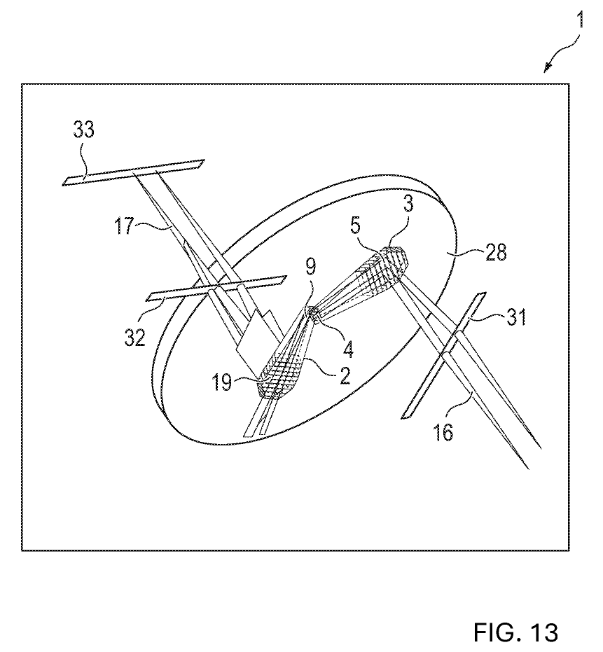

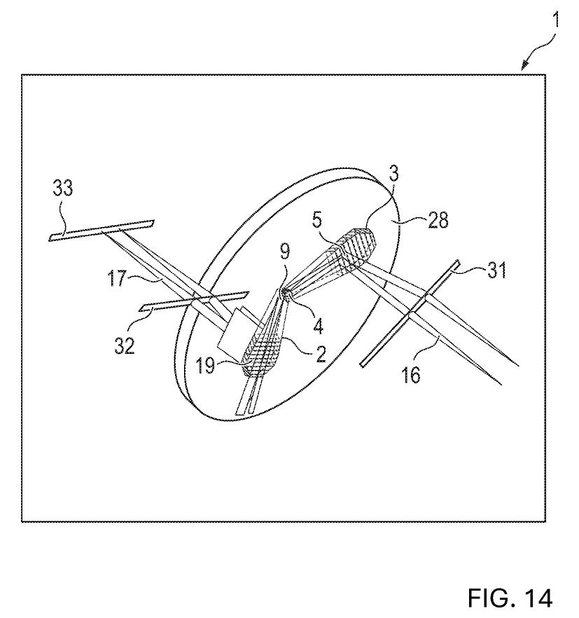

FIGS. 12, 13 and 14 schematically show perspective views of a beam path through a correspondingly simulated optical arrangement 1 according to the disclosure at different azimuthal rotational angles of the further lightguide 3, e.g., a rotation of a longitudinal axis of the further lightguide 3 with respect to a longitudinal axis of the AR lightguide 2 about a coupling point. In FIG. 12, the rotational angle is 145 degrees, in FIG. 13 the rotational angle is 130 degrees, and in FIG. 14 the rotational angle is 115 degrees. The projector was moved up against the further lightguide 3 (right-hand side) such that the projector exit pupil and the AR lightguide pupil are approximately coincident. Also visible on the output coupling side (left-hand side) is the one-dimensional pupil replication; this is precisely as far as these beams would reach in the case of a decentering in the direction of the narrow edge of the detector. Bars 31 and 32 denote in each case the positions of an idealized collimation lens 31 and focusing lens 32. Bar 33 denotes the plane of the eye or of a detector.

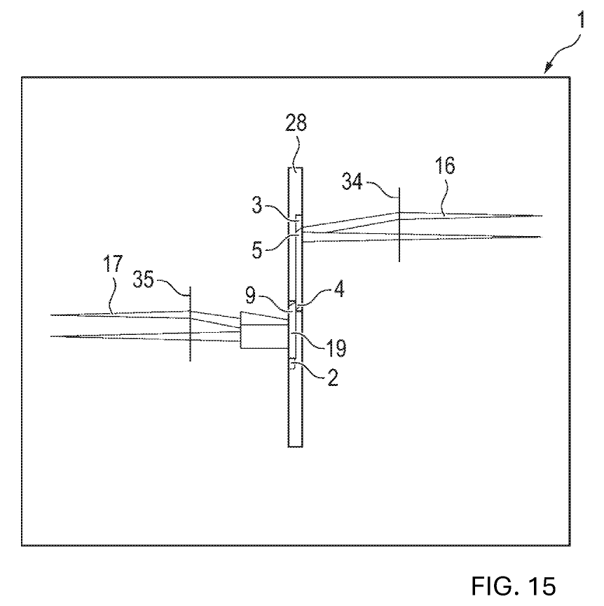

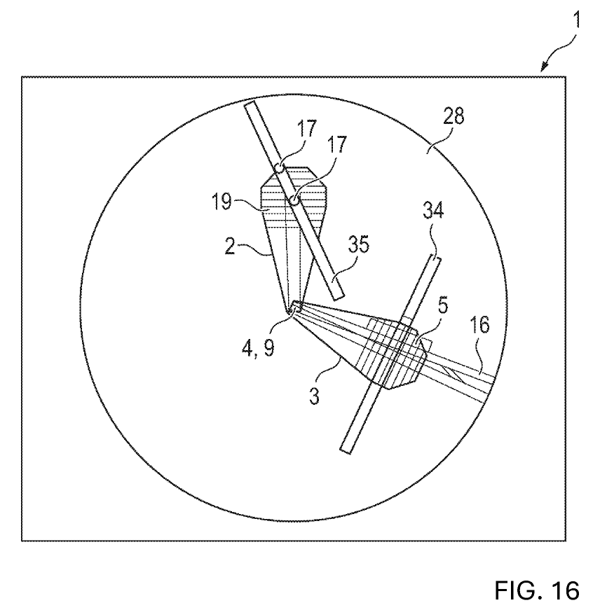

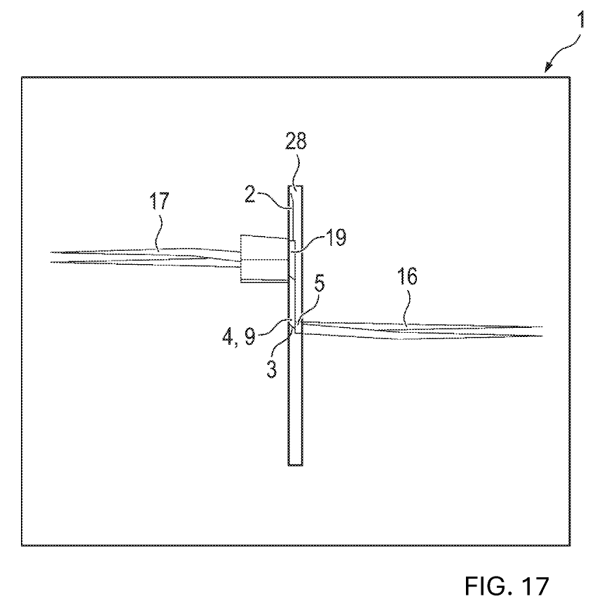

FIG. 15 schematically shows a view of the beam path shown in FIG. 14 through a simulated optical arrangement 1 according to the disclosure in a y-z-plane. FIG. 16 schematically shows a view of the beam path shown in FIG. 14 in an x-y-plane. FIG. 17 schematically shows a view of the beam path shown in FIG. 14 in an x-z-plane. In FIGS. 15-17, bars 34 and 35 denote the positions of an idealized collimation lens in each case.

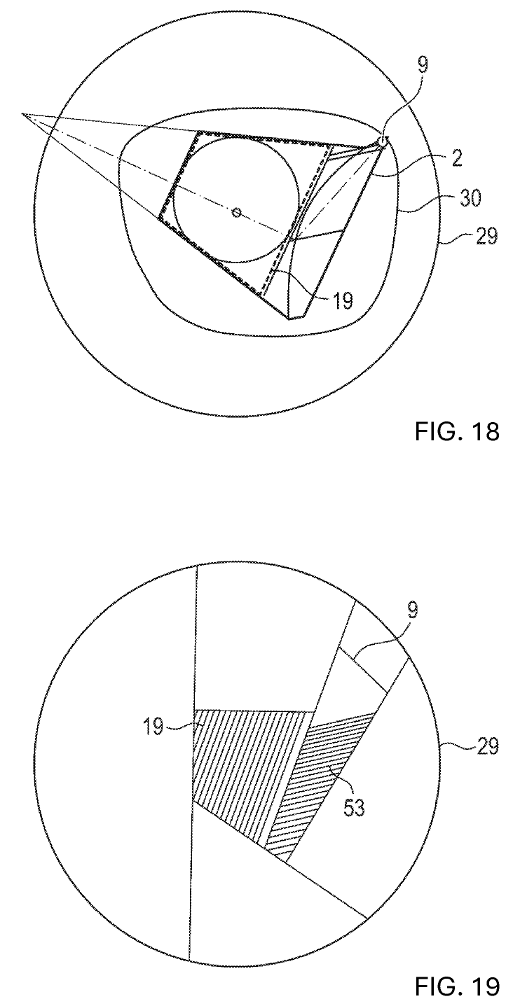

There follows a description, on the basis of FIGS. 18 ff., of how a size-minimized lightguide can be produced. FIG. 18 schematically shows a semifinished product 29 in the form of a wafer with a size-minimized input coupling region, pupil replication region and output coupling region in a lightguide 2. The contour of a lightguide matching an exemplary spectacle lens cutout is denoted by reference sign 30. The wafer is normally suitably cut out for a frame and the associated spectacle lens and the spectacle lens is adhesively bonded over the entire surface area. To reduce the weight, it can be advantageous to cut out the glass wafer along the outer contour denoted by reference sign 2 and fill the missing region, which is to say the area inside the contour 30 as far as the area of the contour 2, with a low-density material (e.g., adhesive, polymer) index-matched to the lightguide.

Since unnecessarily large pupil replication regions and output coupling regions can generate problems of scattered light, it is advantageous when the wafer is formed from assembled segments. FIG. 19 schematically shows a wafer 29 formed from segments. FIG. 20 schematically shows a detail of the wafer 29 shown in FIG. 19, for example centered for a specific frame and specific group of users (intraocular distance). The output coupling regions 19 and pupil replication regions 53, which in the present case are refractive, form individual segments and have minimal dimensions corresponding to the boundary conditions described. This as far as possible avoids scattered light. The individual segments are formed with a simple geometry, which is advantageous in terms of cost-effective manufacture. Joints between the individual segments are not visible in the case of index-matched joining, e.g., by adhesive bonding etc.

For diffractive couplers, instead of or in addition to the refractive couplers shown it is possible to expose diffraction gratings in accordance with the required apertures. In this case, the wafer 29 itself need not be segmented. Here, it is important only to find the ideal aperture, as described in connection with the following figures.

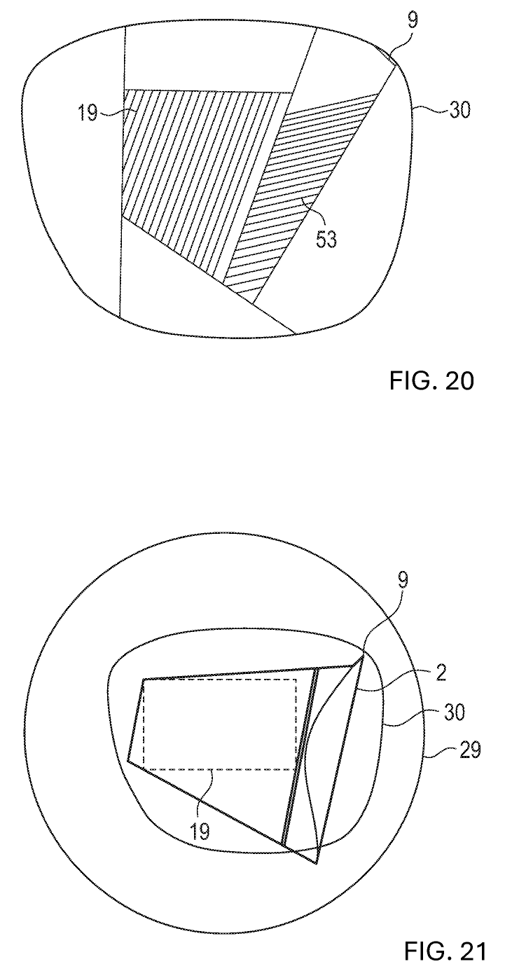

FIG. 21 schematically shows a semifinished product 29 in the form of a wafer with a lightguide 2 for a large group of users. Although this configuration offers an output coupling region 19 suitable for many users, e.g., all users with an intraocular distance of 49 mm to 76 mm, it is imperative to provide a very large lightguide 2 for this. This in turn leads to an increased weight of the spectacle lens and a limited selection of possible spectacle frames.

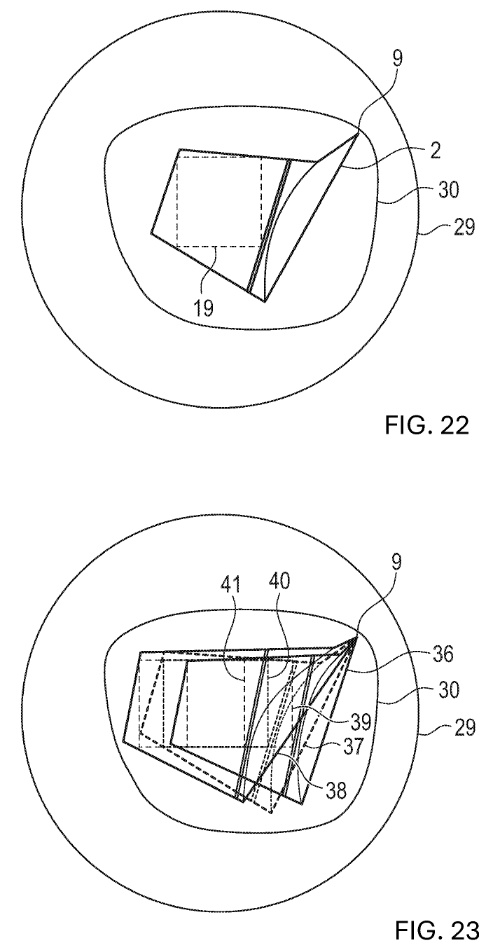

FIGS. 22 and 23 show variants for size-minimized lightguides, with FIG. 22 showing a variant of a size-minimized lightguide 2, e.g., for an intraocular distance of 63 mm to 65 mm, and FIG. 23 showing three variants of size-minimized lightguides, each designed for a specific group of users. The exemplary design is for the right eye side in the viewing direction of the glasses wearer. In the illustration, the nasal side is on the left and the temporal side is on the right. The lightguide 36 with the associated output coupling device 41 can be designed for a first intraocular distance range, e.g., 49 mm to 58 mm. The lightguide 37 with the associated output coupling device 40 can be designed for a second intraocular distance range, e.g., 58 mm to 67 mm, and the lightguide 38 with the associated output coupling device 39 can be designed for a third intraocular distance range, e.g., 67 mm to 76 mm. Furthermore, specific customizations for certain frame models are possible.

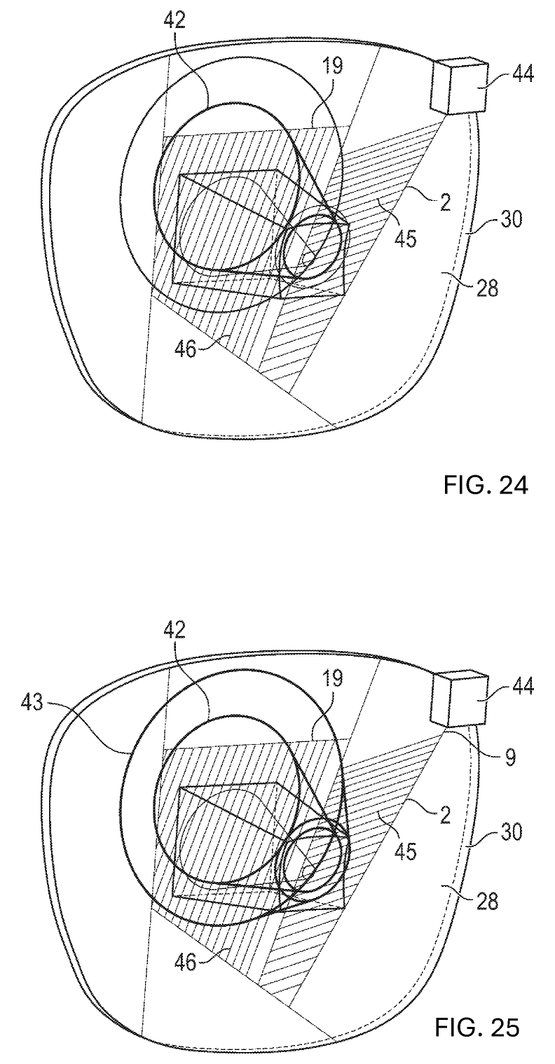

The lightguide with input and output coupling and pupil replication elements, which is demonstrated hereinafter for example, but not exclusively, with partially transmissive mirrors (see reference signs 45 and 46 in FIGS. 24-29), is size-minimized on the basis of a desired field of view of a virtual image and positional tolerances of the optical system with respect to the user. Fundamental parameters are, as already mentioned, in particular the meridional intraocular distance range, the distance range from the waveguide to the eye along the line of sight to the center of the virtual image, the angular orientation of the waveguide in relation to lines of sight of the image contents (for example the line of sight to the image center), the size of the eye pupils, the viewing direction field and the respective fields of view for the virtual image and the transmission, the distance from the eye pupil to the focal plane of the virtual image, the waveguide material, and the position of the input coupling of the image information of an image collimator.

For an arbitrarily selected spectacle frame and image parameters, the following exemplary illustrations shown in FIGS. 18-23 were created using the following data: Distance 1 m from the virtual image, ±17.7° field of view (half field in the sagittal and meridional direction in a square shape), intraocular distance (on the basis of the centers of the eye pupils when looking at an object an infinite distance away) 64 mm with variations as described above, 15 mm distance from the center of the pupil to the waveguide (along the line of sight to the center of the virtual image) with variations between 13 mm and 20 mm (depending on the slipping of the spectacle frame along the nasal bridge of an exemplary human head and conventional eye diameter variations, slip direction of the frame approximately -60° relative to the meridional plane), -10° pantoscopic angle (frame pre-tilt angle) and -10° sagittal angle for the viewing direction toward the center of the virtual image, -2.4° wrap angle (tilt angle of the spectacle lens in relation to the sagittal plane 90° - 2.4°), an eye pupil diameter to be filled with image information of 1.5 mm, a commercial spectacle frame (CT scan) assuming the input coupling of the image information of the image collimator close to the spectacle temple, and a waveguide material with refractive indices at 587.56 nm of between 1.5 and 2.1 (as in the case of glasses N-LAF33, N-LASF46B, N-BAF4 or P-SK60 by Schott, use being made of N-LASF46B for the design variants demonstrated).

FIGS. 24-29 schematically show a spectacle lens with a lightguide 2 and the geometric parameters used in the course of a simulation for size minimization. An input coupling optical unit in the form of an image collimator is denoted by reference sign 44. For the viewing angle region of the eye by rotation of the eyeball, a region of ±17.5° about a viewing direction oriented by -2.5° downward in relation to the meridional plane is assumed. This is shown in FIG. 24, where the corresponding viewing angle region is denoted by reference sign 42. In addition, FIG. 25 illustrates, for orientation purposes, an axially symmetrical field of view 43 of ±30°, which is to say a region in which a person usually still perceives symbols in the peripheral field of view.

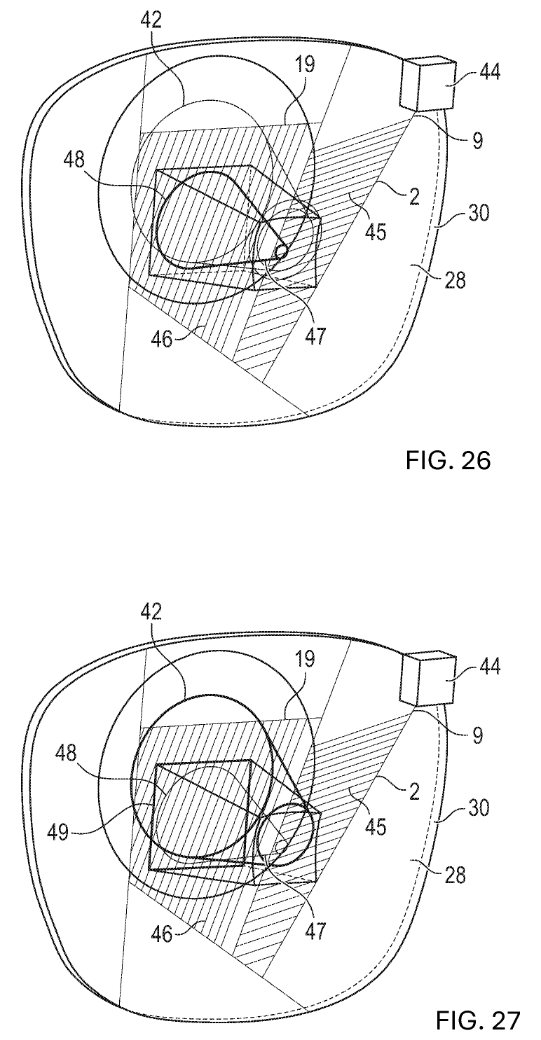

Within the viewing direction cone 42, the eye is oriented such that the line of sight to the center of a virtual image one meter away along the line of sight is directed away from the center of the pupil, tilted by -10 ° about the meridional plane. About this line of sight to the image center, a field of view 47 with ±17.7 ° is constructed, of which the interface 48 with the lightguide rear side is used to identify the region 49, what is referred to as the “minimal output footprint,” from which light is output coupled in the direction of the eye; see FIGS. 26 and 27. The specification is a square virtual image with image corners at ±25 ° field of view from the line of sight to the image center.

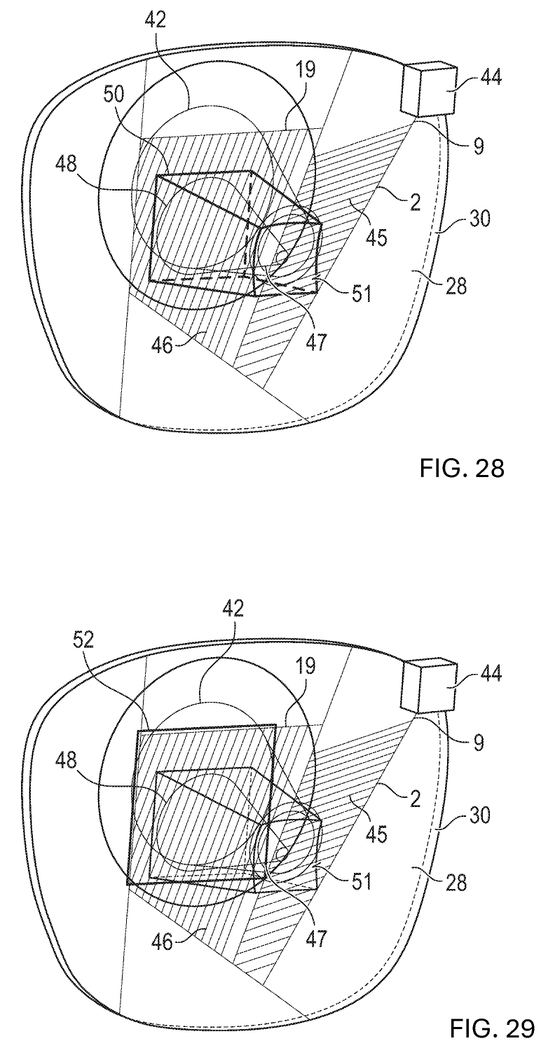

On this basis, a volume 50 is spanned which contains all the viewing directions for a filled eye pupil and indicates the range of movement of the eye pupil; see FIG. 28. For this purpose, an optimization is used to set two orthogonal elevation angles of the eye model such that the eye model looks into the image corners. The area 51 spanned by the movement of the pupil centers is spherical in the ideal case and inter alia depends on the distance between the eye and the lightguide. Generated together with this variation in distance along the line of sight is what is referred to as the “eye box”: a spatial region in which the eye pupil is located for all relevant variations (with a variable angular orientation corresponding to the rotation of the eye).

In addition to this variation, there are positional tolerances for the described optical system relative to the eye pupil or the eye box. These tolerances are for example a possible slipping of the glasses on the nasal bridge downward (e.g., 4 mm downward) or upward (e.g., 1 mm upward), a lateral tolerance of the fastening of the optical system inside the spectacle frame (e.g., ± 1 mm), and measurement tolerances for the intraocular distance (e.g., ± 1 mm). For the variations described, a (partly) automated analysis process is used to record footprints and generate an integrated quadrilateral footprint 52, which is generally no longer exactly square, therefrom; see FIG. 29. The same applies to the eye box. The footprint 52 integrated across all relevant variants specifies the necessary minimum area for output coupling, this as described above being independent of the selected waveguide technology, for example independent of the configuration as diffractive or reflective couplers and pupil replicators.

For further optimization, the integrated footprint 52 is taken as a basis to define a reference geometry consisting of reference coordinate systems, planes, axes and points, and reference curves. The reference geometry can be used for the design of the diffractive and reflective coupling and replication elements. With the reference geometry and the footprint from FIG. 29, for the use case of reflective pupil replication, and input and output coupling, the parameters for as small as possible a lightguide 2 which output couples the input coupled light with a uniform radiation intensity (unit [W/sr]) in the direction of the eye are automatically ascertained in an optimization by predefining the lightguide material (e.g., the glass N-LASF46B by Schott), the eye pupil size to be filled (e.g., 1.5 mm diameter), the desired angular distribution of the pupil replication (e.g., 1°), the lateral minimum extent of the angular distribution (e.g., 1 mm to 1.5 mm) and the desired input coupling position of the image information, e.g., close to the spectacle temple. The corresponding geometry is necessary for a uniform distribution and output coupling of the light, as a result of which the virtual image looks the same in terms of color and brightness for visual perception even with the variances described. The optical design is sufficiently defined by specifically designed partially transmissive mirrors 45 and 46.

The geometric parameters, which are automatically optimized, are the propagation volume of the light inside the lightguide, the number and position of the partially transmissive mirrors 45 and 46, the thickness of the lightguide 2, and the blanks from which the semifinished product in wafer form is formed. The elevation angles of the input and output coupling are designed on the basis of the line of sight to the image center and the pantoscopic angle and the wrap angle, directly inside the geometry model or by means of a coupled optical simulation. Depending on the azimuthal position of the reference geometry, for example depending on the footprint width and/or the input coupling position of the image collimator 44, the lightguide volume is limited to the footprint dimensions in automated fashion by condition-controlled cuts. This avoids superfluous lightguide regions which are unfavorable in terms of optical properties, for example scattered light, and under certain circumstances are unfavorable in terms of the weight. See in this respect FIGS. 19 and 20, which show two examples of wafers 29 with size-minimized lightguides 2 produced according to the method described, with the lightguide 2 shown in FIG. 19 being size-minimized for a large group of users and the lightguide 2 shown in FIG. 20 being size-minimized for a group of users having an intraocular distance in a fixed range.

The necessary reflectances and transmittances of the partially transmissive mirrors 45 and 46 are also ascertained in automated fashion. They depend inter alia on the number of mirrors, which is varied in automated fashion in the geometry optimization. The aforementioned basic radiometric properties of the respective mirrors 45 and 46 are important for a coupled non-sequential optical simulation, which makes it possible to finely optimize all of the above-described parameters. In particular, this relates to a multi-target optimization in terms of volume minimization and optical performance, for example a geometry adaptation that reduces sensitivity to tolerances and scattered light, but can also include coupling to structural-mechanical simulations, for example in order to reduce the sensitivity of the optical system in terms of temperature variations and other mechanical loading.

As required, the radiometric properties of the mirrors and the coupled simulations/multi-target optimizations can be described in detail, this being dispensed with initially here for reasons of time. The partially transmissive mirrors can be implemented for example by dielectric multilayer coatings or holographic optical elements (HOEs).

To fasten the image collimator 44 to the lightguide 2 and align it along the temple of the spectacle frame, a corresponding optical group which itself can be configured as a lightguide is provided. By way of a suitable optical design, for example, the optical group 44 can decouple the alignment of the image collimator along the spectacle temple and the required direction of arrival of the chief ray of the image center from one another. This optical group 44 can be important as a boundary condition for system optimizations.

The described optical design process produces an extent-minimized lightguide 2 that is integrated in a semifinished product 29 in wafer form. This semifinished product 29 is cut out individually for a corresponding frame shape and/or the corresponding group of users. The optical design is carried out in the present case in Creo Parametric. A parametrically coupled optical simulation and fine optimizations can be carried out for example with Zemax.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### LIST OF REFERENCE SIGNS

1 Optical arrangement
2 Lightguide
3 Further lightguide
4 Output coupling device
5 Input coupling device
6 Fastening device
7 Output coupling region
8 Frame
9 Input coupling region/Input coupling device
10 Rotation
11 Rotation
12 Projector
13 Axial displaceability
14 Eye
15 Pupil position
16 Beam path
17 Beam path
19 Output coupling device, output coupling region
20 Schmidt-Pechan prism
21 Beam path
22 Optical unit
23 Optical unit
24 Mirror
5 Mirror
26 Light beam
27 Light beam
28 Spectacle lens
29 Wafer
30 Contour for spectacle lens cutout
31 Position of an idealized collimation lens
32 Position of an idealized focusing lens
33 Detector plane
34 Position of an idealized collimation lens
35 Position of an idealized collimation lens
36 Lightguide
37 Lightguide
38 Lightguide
39 Output coupling device
40 Output coupling device
41 Output coupling device
42 Viewing angle region
43 Field of view
44 Input coupling optical unit / image collimator
45 Partially transmissive mirror
46 Partially transmissive mirror
47 Constructed field of view
48 Area of intersection of the constructed field of view with the waveguide rear side (“footprint”)
49 Output coupling region
50 Volume spanned
51 Area spanned by the movement of the pupil center
52 Integrated quadrilateral footprint
53 Pupil replication region

1. An optical arrangement comprising:
a lightguide for radiating in images that are perceptible as virtual images; and a fastening device for fastening the optical arrangement to a person’s head,
wherein the fastening device includes an output coupling region for arrangement of a projector,
wherein the lightguide has an input coupling region,
wherein the optical arrangement has a further lightguide with an input coupling device and an output coupling device,
wherein the further lightguide is arranged in a beam path between the output coupling region of the fastening device and the input coupling region of the lightguide.

2. The optical arrangement as claimed in claim 1, wherein the output coupling region of the fastening device is connected or connectable to the input coupling device of the further lightguide and/or
the output coupling device of the further lightguide is connected or connectable to the input coupling region of the lightguide.

3. The optical arrangement as claimed in claim 1, wherein the further lightguide is configured as a periscope lightguide,
and/or the input coupling device and/or the output coupling device of the further lightguide are/is refractive and/or diffractive and/or reflective and/or transmissive and/or include(s) at least one holographic optical arrangement.

4. The optical arrangement as claimed in claim 1, wherein the lightguide and/or the further lightguide are/is customized in accordance with at least one fixed customization parameter and/or are/is formed from segments.

5. The optical arrangement as claimed in claim 4, wherein the at least one customization parameter is an intraocular distance and/or a head width and/or at least one geometric parameter of a spectacle frame and/or a position of the input coupling region of the lightguide and/or a position of the output coupling region.

6. The optical arrangement as claimed in claim 4, wherein the at least one customization parameter is a length of the further lightguide and/or a position of the further lightguide in relation to the lightguide and/or a rotational angle of the further lightguide relative to the lightguide.

7. The optical arrangement as claimed in claim 1, wherein the optical arrangement comprises a spectacle frame with a frame contour and the further lightguide is arranged for displacement inside the frame contour.

8. The optical arrangement as claimed in claim 1, wherein the further lightguide is configured as a plane lightguide and/or is configured to guide light waves in a sagittal direction.

9. The optical arrangement as claimed in claim 1, wherein a rotational angle of a longitudinal axis of the further lightguide in relation to a fixed input coupling point into the lightguide and a rotational angle of an image to be input coupled in relation to a fixed input coupling point into the further lightguide have a same absolute value and a same direction.

10. The optical arrangement as claimed in claim 1, wherein an optical device which brings about a complete image inversion without a beam offset is arranged in the beam path between a projector and the input coupling device of the further lightguide.

11. The optical arrangement as claimed in claim 1, wherein the optical arrangement comprises a projector, which is arranged and/or set such that the exit pupil of the projector lies on the input coupling region of the lightguide or in the further lightguide.

12. The optical arrangement as claimed in claim 1, wherein the optical arrangement comprises a projector, which is arranged for axial displacement along the fastening device, and/or the optical arrangement comprises an optical device, which is arranged in the beam path between the projector and the further lightguide and is configured to adapt the exit pupil position of the projector.

13. The optical arrangement as claimed in claim 1, wherein the optical arrangement comprises an optical device for correcting an angle of the fastening device in relation to the input coupling device of the further lightguide, wherein the optical device is arranged between the output coupling region of the projector and the input coupling device of the further lightguide.

14. The optical arrangement as claimed in claim 1, wherein the optical arrangement comprises at least one lens, which includes a cutout or recess adapted to the geometry of the further lightguide and/or wherein the refractive index and/or the refractive index dispersion of the further lightguide is adapted to the refractive index and/or the refractive index dispersion of the at least one lens and/or to an interface arranged between the further lightguide and the lens.

15. The optical arrangement as claimed in claim 1, wherein the lightguide is embodied as a size-minimized lightguide and the further lightguide is embodied as a length- corrected and/or rotational-angle-corrected further lightguide.

16. A head-mounted display comprising an optical arrangement as claimed in claim 1.
